(19) United States
(12) Patent Application Publication
(10) Pub. No.: US 2019/0370537 A1
(43) Pub. Date: Dec. 5, 2019

(54) KEYPOINT DETECTION TO HIGHLIGHT SUBJECTS OF INTEREST

(71) Applicant: Umbo CV Inc., San Francisco, CA (US)

(72) Inventors: Chao-Yi Chen, Taipei City (TW); Tingfan Wu, Taipei City (TW)

(21) Appl. No.: 15/991,100

(22) Filed: May 29, 2018

(51) Int. Cl. G06K 9/00; G06T 11/20

(52) U.S. Cl. CPC G06K 9/00369; G06K 9/00771; G06T 2207/30196; G06T 2207/20044; G06T 11/203

(57) ABSTRACT

Techniques to use keypoint detection to highlight a subject of interest are disclosed. In various embodiments, image data comprising an image is processed to detect a set of keypoints on a human subject included in an image comprising the image data. The image data is processed to detect a set of additional points associated with a surface of the human subject. At least adjacent ones of said keypoints and additional points are connected to generate a mesh overlay. The mesh overlay is combined with the image to generate a composite in which the mesh overlay is superimposed over the human subject.

### BACKGROUND OF THE INVENTION

In security (e.g., video surveillance) and other application, it may be helpful to automatically process video or other image content to detect and highlight a subject of interest. For example, in a security application, it may be desired to process video content generated by one or more security cameras, identify a subject of interest, such as a human subject moving through a field of view, and to provide a display in which the subject of interest is highlighted.

In some cases, highlight the subject may not be sufficient to enable a human viewer of the displayed video content, or a system, to determine whether to trigger an alert or other responsive action. For example, it may be difficult to determine whether a user has crossed into a protected area, interacted in an impermissible way with an object in the environment, etc.

### BRIEF DESCRIPTION OF THE DRAWINGS

Various embodiments of the invention are disclosed in the following detailed description and the accompanying drawings.

FIG. 1 is a flow chart illustrating an embodiment of a process to detect human keypoints to generate a display.

FIG. 2A is a diagram illustrating an example of a human subject such as may be present in video processed by a system to detect human keypoints to generate a display in various embodiments.

FIG. 2B is a diagram illustrating the example human subject of FIG. 2A with detected keypoints and lines connecting them.

FIG. 2C is a diagram illustrating the example human subject as shown in FIG. 2B with additional points on the outline of the human subject detected.

FIG. 2D is a diagram illustrating the example human subject as shown in FIG. 2C with lines connecting the additional points with adjacent keypoints and/or adjacent additional points to form a triangular mesh.

FIG. 3A is a diagram illustrating an example of a human subject in a first pose as displayed in an embodiment of a system to detect human keypoints to generate a display.

FIG. 3B is a diagram illustrating the example human subject in a second pose as displayed in an embodiment of a system to detect human keypoints to generate a display.

FIG. 4 is a diagram illustrating an example of a composite display generated by an embodiment of a system to detect human keypoints to generate a display.

FIGS. 5A and 5B illustrate a segmentation and conversion process used in various embodiments to determine additional points to be used to generate a mesh overlay as disclosed herein.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to detect keypoints in a human of other subject of interest and to generate a display based at least in part on the detected keypoints. In various embodiments, at least a subset of detected keypoints of a human subject may correspond to bendable joints of the subject, enabling pose estimation to be performed with respect to the subject. In some embodiments, detected keypoints may include locations other than bendable joints, such as facial features (nose, ears, corners of eyes), center of torso, top of pelvis, etc. In some embodiments, an overlay or other video or image component is generated based on the detected keypoints. A composite that combines the keypoint display with the video or other image data based on which the keypoints were detected is generated. In some embodiments, lines connecting the keypoints to form a pseudo-skeleton may be generated and included in one or both of the overlay and the composite. In some embodiments, the composite video (or image) is displayed to a human user.

In some embodiments, additional points, such as points on the outer surface of the subject, are detected. Lines connecting the additional points to adjacent keypoints are drawn to form a mesh, e.g., a triangular mesh approximating the outline of the human body and its estimated pose.

In some embodiments, keypoints are used to detect specific interactions with the environment in which the subject was present when the video or other image data was generated. For example, keypoints corresponding to hands may be detected near an object of interest. Or, keypoints associated with the subjects feet may be detected crossing a threshold into a restricted area, in a boundary area at the top of a wall, etc.

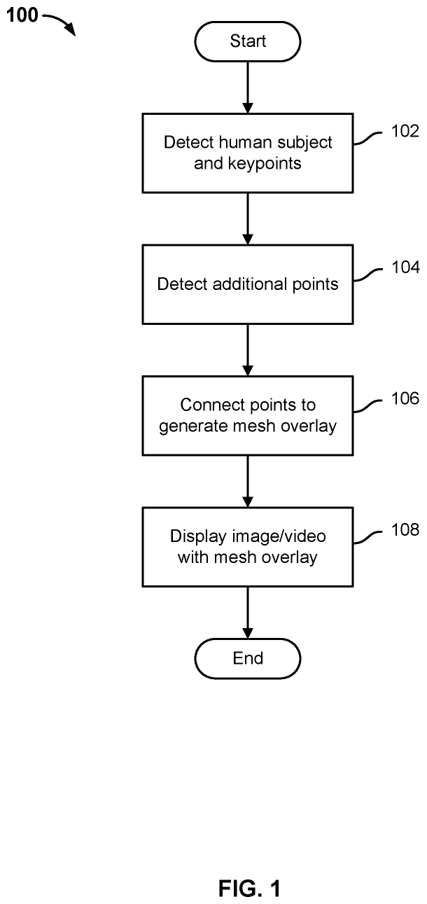

FIG. 1 is a flow chart illustrating an embodiment of a process to detect human keypoints to generate a display. In various embodiments, the process 100 of FIG. 1 may be performed by one or more computers, such as one or more computers configured to receive video and/or image data generated by one or more cameras. In various embodiments, the one or more cameras may include 2D cameras, 3D cameras, or a combination thereof. The computer may be connected locally to the cameras, at a remote monitoring and/or processing location, and/or a combination of local and remote computers. All or part of the process 100 may be performed, in some embodiments, by a processor comprising or otherwise associated with a camera that generated all or part of the video or other image content.

In the example shown, at 102 a human subject and associated keypoints of the subject are detected. In various embodiments, keypoints of the human body are detected at least in part by detecting one or more of extremities, body parts, and joints of the human subject. In some embodiments, keypoint detection is performed at least in part using the OpenPose™ library developed and made available by Carnegie Melon University (CMU)™, sometimes referred to as “CMU OpenPose”.

At 104, additional points are detected. For example, in some embodiments, additional points on the surface of at least portions of a human subject for which keypoints have been detected are detected. Surface points are detected in some embodiments by detecting an outer edge or outline of a human subject, e.g., where the human subject portion of the image ends and the environment portion of the image begins. In some embodiments, additional points are determined to achieve one or more of a desired spacing, density, and/or relationship to detected keypoints.

At 106, lines connecting detected points are determined to generate a mesh overlay. For example, in some embodiments, adjacent keypoints are connected by a first type of line to generate a “skeleton” comprising keypoints and the lines connecting them. Additional (e.g., body surface) points are connected to adjacent/nearby keypoints and, in some embodiments, to adjacent additional points, e.g., using a second type of line. In various embodiments, the second type of line may have different attributes than the first type of line, such as color, thickness, opacity, etc. The keypoints, additional points, and respective lines connecting them are used to generate an overlay.

In various embodiments, for each of at least a subset of successive frames comprising a video a corresponding overlay is generated in which the detected keypoints, additional points, and lines are drawn in locations corresponding to the respective locations of the portions of the human subject as represented in the corresponding frame(s) of video. For example, the keypoints and additional points associated with the human subject's head may be rendered in the overlay at locations corresponding to where the head is represented in the frame(s) of video.

In various embodiments, the keypoints, additional points, and lines connecting them form a triangular mesh, and the overlay generated at 106 comprises a triangular mesh overlay that coincides with the associated human subject as depicted in the associated frame(s) of the video.

At 108, a composite image/video in which the overlay generated at 106 has been merged with the original video content is displayed. For example, in a security or other surveillance system, the composite video may be displayed to an operator monitoring the video feed from a location in which the camera(s) that generated video content processed via the process 100 of FIG. 1 are present.

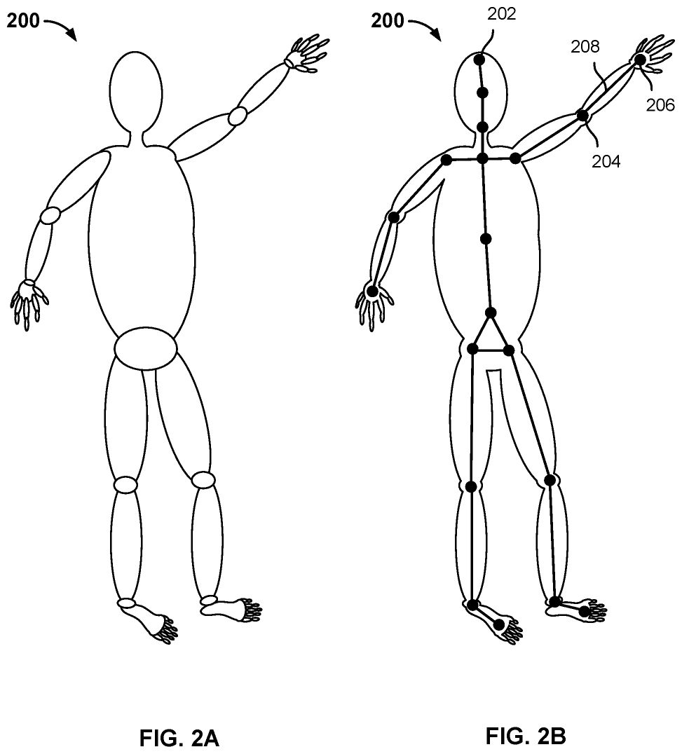

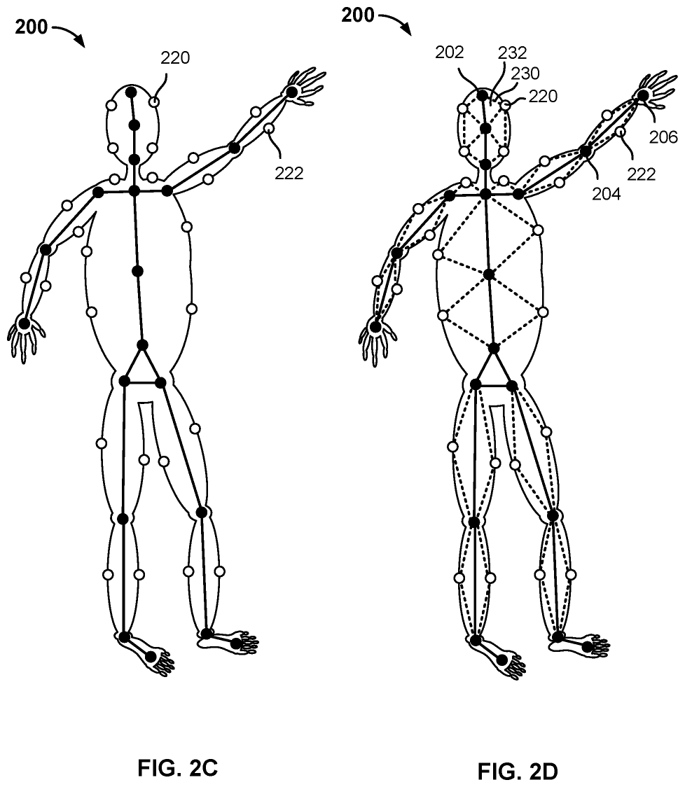

FIG. 2A is a diagram illustrating an example of a human subject such as may be present in video processed by a system to detect human keypoints to generate a display in various embodiments. In some embodiments, the human subject 200 of FIG. 2A may be detected in video processed according to the process 100 of FIG. 1. In the example shown, human subject 200 is shown in outline form with various joints and body parts represented to illustrate keypoint and additional point detection as disclosed herein. In various embodiments, the human subject 200 of FIG. 2A may comprise an actual image or portion thereof showing all or part of a detected human subject.

FIG. 2B is a diagram illustrating the example human subject of FIG. 2A with detected keypoints and lines connecting them. In the example shown, twenty keypoints have been detected, however, in various embodiments any number of keypoints may be detected. In the example shown, keypoints such as 202 (top of head/face), 204 (elbow), 206 (hand), and 208 (forearm) have been detected. In some embodiments, additional keypoints, such as keypoints associated with individual finger joints, may be detected. In some embodiments, the number and type of keypoints detected may depend on the scale, such as how much of the frame is occupied by all or part of the human subject. For example, if a human hand occupies more than a prescribe portion of a frame, in some embodiments keypoints associated with individual fingers and finger joints may be detected.

In the example shown in FIG. 2B, lines connecting adjacent keypoints have been drawn, providing a “skeleton” comprising the detected keypoints and lines connecting them. As can be seen from the example in FIG. 2B, the skeleton reflects the essence of the human subject's pose.

FIG. 2C is a diagram illustrating the example human subject as shown in FIG. 2B with additional points on the outline of the human subject detected. In the example shown, additional points on the surface of the human subject 200 have been detected, such as additional points 220 and 222. In this example, additional points are displayed in a manner that differentiates them visually from keypoints, in this case by being filled white instead of solid black. In some alternative embodiments, keypoints and additional points may be displayed in the same way, or may be distinguished from one another, as displayed, in other ways, such as by using smaller or less dark or opaque dots to represent additional points.

FIG. 2D is a diagram illustrating the example human subject as shown in FIG. 2C with lines connecting the additional points with adjacent keypoints and/or adjacent additional points to form a triangular mesh. In this example, additional points are connected to nearby keypoints by a different type of lines than the lines connecting keypoints, as indicated in FIG. 2C by representing lines connecting additional points to keypoints as dashed lines. In this example, additional point 220 is connected to adjacent keypoints by dashed lines, such as line 230 connecting additional point 220 to keypoint 202, to form a triangle 232 comprising part of the triangular mesh shown.

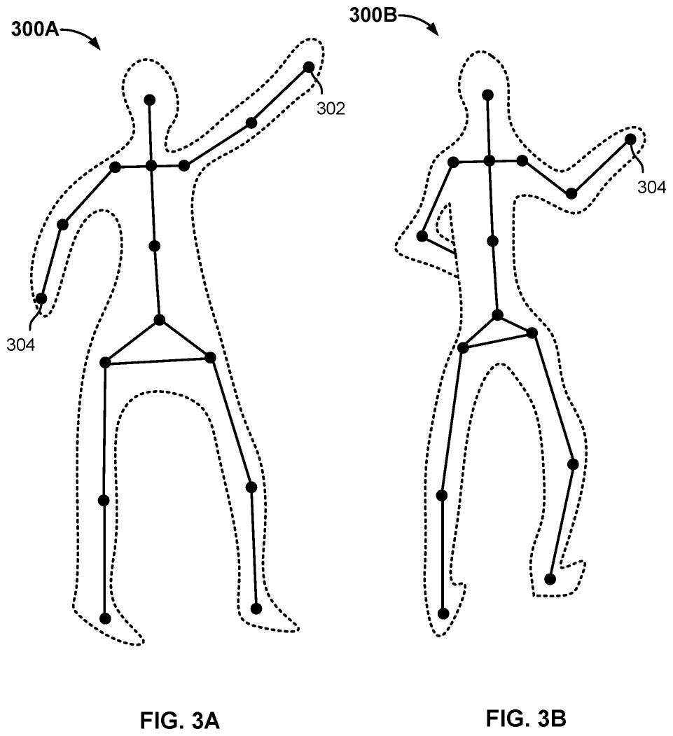

FIG. 3A is a diagram illustrating an example of a human subject in a first pose as displayed in an embodiment of a system to detect human keypoints to generate a display. In the example shown, keypoints of a human subject 300A have been detected, e.g., keypoints 302 and 304 associated with the subject 300A's left and right hands, respectively, and adjacent keypoints have been connected to form a “skeleton” that reflects the pose of the human subject 300A as shown.

FIG. 3B is a diagram illustrating the example human subject in a second pose as displayed in an embodiment of a system to detect human keypoints to generate a display. In the example shown, the human subject 300A of FIG. 3A is shown to have turned to walk away from a camera that captures the (virtual) images of FIGS. 3A and 3B. The keypoint 304 associated with the right hand of the human subject (300A, 300B) is shown in a new position in FIG. 3B, and the left hand associated with keypoint 302 as shown in FIG. 3A is obscured by the human subject's body in the pose as shown in FIG. 3B.

In various embodiments, detecting human keypoints and connecting them to form a skeleton, and then using an overlay or other techniques to superimpose the keypoints and lines comprising the skeleton onto the corresponding human subject as captured and portrayed in the source video enables a composite video to be provided that makes it easier for a viewer of the composite video to determine the location, motion, and apparent future direction of movement of a human subject. Such techniques may enable an operator in a security or other surveillance context, for example, to determine whether a human subject portrayed in video content has accessed or intends to access a restricted area, etc.

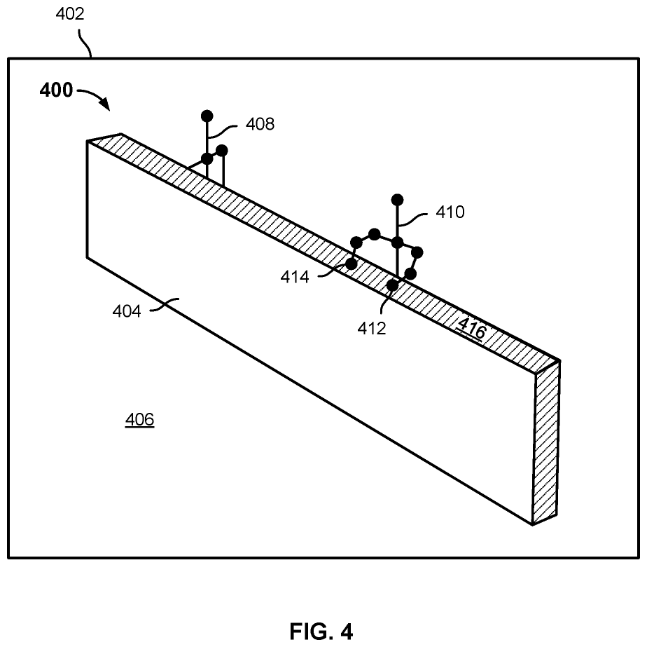

FIG. 4 is a diagram illustrating an example of a composite display generated by an embodiment of a system to detect human keypoints to generate a display. In the example shown, a scene 400 is displayed via a display device 402, such as a computer, tablet, mobile device, or other display screen. In the example shown, scene 400 includes a wall 404 that prevents unauthorized persons from accessing a protected premises 406. In the example shown, a first passerby is represented by a keypoint-based skeleton 408. In the example shown, a corresponding image of the actual person with whom keypoint-based skeleton 408 is associated is not displayed, but in some embodiments the keypoint-based skeleton 408 would be shown superimposed over the associated human subject. From the pose represented by keypoint-based skeleton 408, one can see the associated human subject is walking along the wall 404 on the far side from protected premises 406. By contrast, a second human subject, represented in this example by keypoint-based skeleton 410, appears to be attempting to scale the wall 404. Specifically, in the example shown, keypoints 412 and 414, associated with the subject's left and right hands, respectively, appear in a location that at least suggests the subject's hands have been placed on the top surface 416 of wall 404.

The example shown in FIG. 4 illustrates that keypoint detection and overlay generation, as disclosed herein, may enable a composite video to be generated and displayed that makes it easier for a human operator viewing the composite video to determine whether a human subject is of interest or concern, or not.

In some embodiments, keypoints detected as disclosed herein may be used to detect encroachment in a secured area through at least partly automated processing. For example, in the example shown in FIG. 4, overlapping of the hand keypoints 412 and 414 in some embodiments would be detected via automated processing and an alert sent in response to detecting apparent encroachment of the trigger area (top surface 416 of wall 404) by specified keypoints, in this case the hands (412, 414).

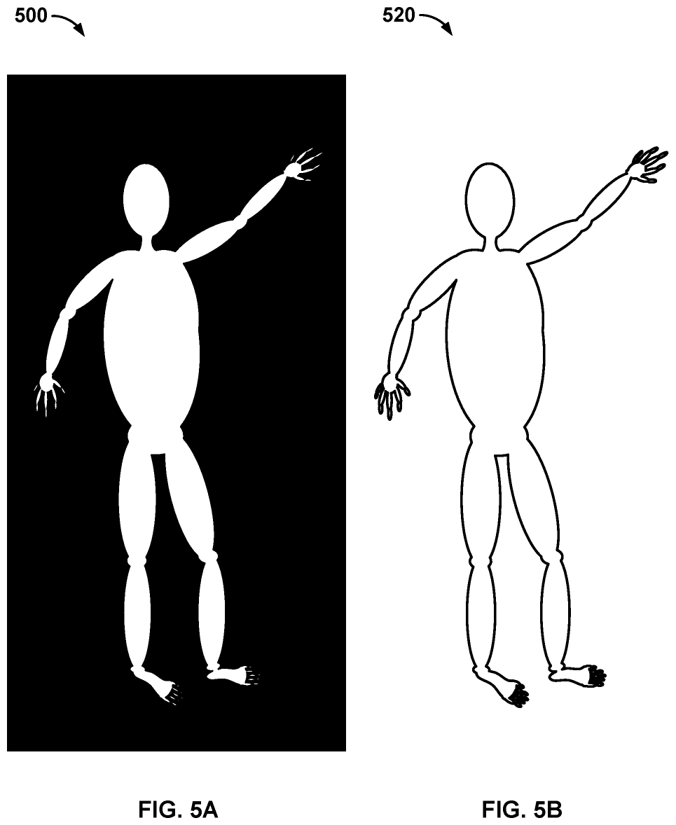

FIGS. 5A and 5B illustrate a segmentation and conversion process used in various embodiments to determine additional points to be used to generate a mesh overlay as disclosed herein. In various embodiments, step 104 of the process of FIG. 1 is implemented at least in part by techniques as illustrated in FIGS. 5A and 5B. In the example shown in FIG. 5A, a frame of video or other image showing the person subject 200 of FIG. 2A in a filmed scene or setting, e.g., a frame of video generated by a surveillance camera, has been segmented to distinguish portions of the image associated with the subject of interest from other portions, resulting in a segmented frame 500. In various embodiments, known segmentation techniques are used to generate the segmented frame 500. As illustrated in FIG. 5B, the segmented frame 500 is used to derive an outline 520 of the subject of interest. In some embodiments, the segmentation 500 and/or outline 520 is/are converted to a many-sided polygon that circumscribes and/or otherwise approximates the outline 520. Vertices of the polygon are added as additional “keypoints” (e.g., in some embodiments, treated as additional “joints”) and used to generate a mesh overlay, as shown in FIG. 2D, for example.

In various embodiments, techniques disclosed herein enable surveillance and other video to be enhanced by superimposing keypoints, keypoint-based skeletons, and/or triangular or other mesh overlays, enable the pose and potentially intentions of a human subject to be determined more readily by a human operator who views the enhanced video. In various embodiments, techniques disclosed herein may be used to generate automatically alerts or other responsive action, e.g., based on user-defined rules regarding the interaction of specific detected keypoints of a human subject with a defined portion of the environment comprising a filmed scene.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory or other storage device configured to store image data; and
a processor couple to the memory or other storage device and configured to:
process the image data to detect a set of keypoints on a human subject included in an image comprising the image data;
process the image data to detect a set of additional points associated with a surface of the human subject;
connect at least adjacent ones of said keypoints and additional points to generate a mesh overlay; and
combine the mesh overlay with the image to generate a composite in which the mesh overlay is superimposed over the human subject.

2. The system of claim 1, wherein the processor is further configured to detect the human subject in the image.

3. The system of claim 1, wherein the processor is further configured to display the composite.

4. The system of claim 1, wherein the image comprises a frame included in a video comprising a plurality of frames, and wherein the composite is one of a plurality of composites, each corresponding to one or more corresponding frames of the video.

5. The system of claim 4, wherein the processor is further configured to cause a composite video comprising the composite to be displayed via a display device.

6. The system of claim 5, wherein each of a plurality of frames comprising the composite video comprises a composite frame generated at least in part by combining a mesh overlay generated for that frame with the original frame.

7. A method, comprising:
processing image data comprising an image to detect a set of keypoints on a human subject included in an image comprising the image data;
processing the image data to detect a set of additional points associated with a surface of the human subject;
connecting at least adjacent ones of said keypoints and additional points to generate a mesh overlay; and
combining the mesh overlay with the image to generate a composite in which the mesh overlay is superimposed over the human subject.

8. The method of claim 7, further comprising detecting the human subject in the image.

9. The method of claim 7, further comprising displaying the composite.

10. The method of claim 7, wherein the image comprises a frame included in a video comprising a plurality of frames, and wherein the composite is one of a plurality of composites, each corresponding to one or more corresponding frames of the video.

11. The method of claim 10, further comprising causing a composite video comprising the composite to be displayed via a display device.

12. The method of claim 11, wherein each of a plurality of frames comprising the composite video comprises a composite frame generated at least in part by combining a mesh overlay generated for that frame with the original frame.

13. A computer program product embodied in a tangible computer readable medium, comprising computer instructions for:
processing image data comprising an image to detect a set of keypoints on a human subject included in an image comprising the image data;
processing the image data to detect a set of additional points associated with a surface of the human subject;
connecting at least adjacent ones of said keypoints and additional points to generate a mesh overlay; and
combining the mesh overlay with the image to generate a composite in which the mesh overlay is superimposed over the human subject.

14. The computer program product of claim 13, further comprising computer instructions for detecting the human subject in the image.

15. The computer program product of claim 13, further comprising computer instructions for displaying the composite.

16. The computer program product of claim 13, wherein the image comprises a frame included in a video comprising a plurality of frames, and wherein the composite is one of a plurality of composites, each corresponding to one or more corresponding frames of the video.

17. The computer program product of claim 16, further comprising computer instructions for causing a composite video comprising the composite to be displayed via a display device.

18. The computer program product of claim 17, wherein each of a plurality of frames comprising the composite video comprises a composite frame generated at least in part by combining a mesh overlay generated for that frame with the original frame.
